(19) United States
(12) Patent Application Publication
(10) Pub. No.: US 2007/0057496 A1
(43) Pub. Date: Mar. 15, 2007

(54) Gas generator for air bag

(75) Inventors: Naoki Matsuda, Tatsuno-Shi (JP); Mikio Yabuta, Tatsuno-shi (JP)

Correspondence Address: BIRCH STEWART KOLASCH & BIRCH, PO BOX 747, FALLS CHURCH, VA, 22040-0747, US

(73) Assignee: Daicel Chemical Industries, Ltd., Sakai-Shi (JP)

(21) Appl. No.: 11/448,039

(22) Filed: Jun. 7, 2006

Related U.S. Application Data
(60) Provisional application No. 60/689,575, filed on Jun. 13, 2005.
(60) Provisional application No. 60/730,373, filed on Oct. 27, 2005.

(30) Foreign Application Priority Data
Jun. 8, 2005 (JP) 2005-168510
Oct. 21, 2005 (JP) 2005-306591

(51) Int. Cl. B60R 21/26

(52) U.S. Cl. 280/737; 280/740; 280/741

(57) ABSTRACT

A gas generator for an air bag, comprises, in a housing having a gas discharge port, a first combustion chamber and a second combustion chamber in which a gas generating agent and an ignition device are provided respectively. The second combustion chamber is separated from the first combustion chamber by a combustion chamber cup member disposed within the housing, and a second gas generating agent and a second ignition device are disposed within the combustion chamber cup member. The peripheral surface of the combustion chamber cup member has a fragile section adapted to be cleaved at the fragile section by activation of the second ignition device, thereby forming a discharge channel for the gas generated in the second combustion chamber.

This nonprovisional application claims priorities under 35 U.S.C. § 119(a) on Patent Applications No. 2005-168510 filed in Japan on Jun. 8, 2005 and No. 2005-306591 filed in Japan on Oct. 21, 2005 and 35 U.S.C. § 119(e) on U.S. Provisional Applications No. 60/689575 filed on Jun. 13, 2005 and No. 60/730373 filed on Oct. 27, 2005, which are incorporated by reference.

### BACKGROUND OF THE INVENTION

1. Field of the Invention

The present invention relates to a gas generator for an air bag that can be used in a passenger restraining apparatus in an automobile.

2. Description of the Related Art

Automobile makers have made demands for a gas generator for an air bag having reduced size and weight which is used in a passenger restraining apparatus in an automobile. An effective method of responding to these demands is to reduce the number of components in the gas generator by simplifying the structure thereof while maintaining required performance and quality levels.

FIG. 1 of U.S. Pat. No. 6,189,927 B1 (JP-A No. 2002-503584) shows an air bag inflator in which a second chamber 82 is housed within a first chamber 34. A gas outlet orifice 104 of the second chamber 82 is covered by an insulation barrier material 106 which is opened or ruptured when a predetermined pressure is applied thereto from the interior of the second chamber 82.

FIG. 1 of U.S. Pat. No. 6,543,805 B2 shows an inflator 10 having a first combustion chamber 200 and a second combustion chamber 180 which are separated by a fixed partition wall. This publication discloses that an igniter cap 220 inside the first combustion chamber 200 slides in an axial direction when pushed by the combustion products of an ignition agent 222.

FIG. 1 of JP-A No. 2001-199303 shows a gas generator for an air bag having two combustion chambers 5a, 5b.

In an emergency gas generator of JP-A No. 5-168905, a V groove 5 is provided in a bottom plate 3 of a case 1, and when a gas combustion generating agent 2 is ignited and gas is generated by activation of a squib 8, the bottom plate 3 is broken at the V groove 5 and gas is released therefrom to the outside.

### SUMMARY OF THE INVENTION

The present invention provides a gas generator for an air bag, comprising:

a housing having a gas discharge port;

a first combustion chamber and a second combustion chamber, included in the housing;

a gas generating agent and an ignition device provided in each of the first combustion chamber and the second combustion chamber;

a combustion chamber cup member provided in the housing for separating the second combustion chamber from the first combustion chamber; and

a gas generating agent and an ignition device disposed within the combustion chamber cup member,

wherein, a peripheral surface of the combustion chamber cup member has a fragile section, and

the peripheral surface is adapted to be cleaved at the fragile section by an activation of the ignition device, thereby forming a discharge channel for the gas generated in the second combustion chamber.

The invention provides a gas generator for an air bag, comprising:

a housing having a gas discharge port;

a first combustion chamber and a second combustion chamber, included in the housing;

a gas generating agent and an ignition device, provided in each of the first combustion chamber and the second combustion chamber; and,

an enhancer chamber cup member provided in the housing for separating, from the first combustion chamber, an enhancer chamber accommodating a first ignition device, an enhancer agent, and a space accommodating a gas generating agent,

wherein, a peripheral surface of the enhancer chamber cup member has a fragile section, the peripheral surface is adapted to be cleaved at the fragile section by an activation of the first ignition device, thereby releasing a combustion product into the first combustion chamber.

The present invention provides a gas generator for an air bag, comprising:

a housing having a gas discharge port;

a first combustion chamber and a second combustion chamber, included in the housing;

a gas generating agent and an ignition device, provided in each of the first combustion chamber and the second combustion chamber;

an enhancer chamber cup member provided in the housing for separating, form the first combustion chamber,

an enhancer chamber accommodating a first ignition device, an enhancer agent, and a space accommodating a gas generating agent, a peripheral surface of the enhancer chamber cup member having a fragile section, the peripheral surface being adapted to be cleaved at the fragile section by an activation of the first ignition device, thereby releasing a combustion product into the first combustion chamber; and

a combustion chamber cup member provided in the housing for separating, the second combustion chamber from the first combustion chamber, the second combustion chamber, the combustion cup member accommodating a second gas generating agent and a second ignition device, a peripheral surface of the combustion chamber cup member having a fragile section, and the peripheral surface being adapted to be cleaved at the fragile section by an activation of the second ignition device, thereby forming a discharge channel for the gas generated in the second combustion chamber.

The invention provides a gas generator for an air bag, comprising:

a housing having a gas discharge port;

a combustion chamber provided in the housing;

a gas generating agent and an ignition device, provided in the combustion chamber;

an enhancer chamber cup member provided in the combustion chamber for separating, from the combustion chamber, an enhancer chamber accommodating an ignition device, an enhancer agent, a peripheral surface of the enhancer chamber cup member having a fragile section, the peripheral surface being adapted to be cleaved at the fragile section by an activation of the ignition device, thereby releasing a combustion product into the combustion chamber.

The present invention, in other words, relates to a gas generator for an air bag, including, in a housing having a gas discharge port, a first combustion chamber and a second combustion chamber, in which a gas generating agent and an ignition device are provided respectively,

the second combustion chamber being separated from the first combustion chamber by a combustion chamber cup member disposed within the housing, and a second gas generating agent and a second ignition device being disposed within the combustion chamber cup member, and

the peripheral surface of the combustion chamber cup member having a fragile section, and the peripheral surface being cleaved at the fragile section by activation of the second ignition device, thereby forming a discharge channel for the gas generated in the second combustion chamber.

Further, the present invention relates to a gas generator for an air bag, including, in a housing having a gas discharge port, a first combustion chamber and a second combustion chamber, in which a gas generating agent and an ignition device are provided respectively,

the first combustion chamber being separated by an enhancer chamber cup member, which is disposed in the first combustion chamber, into an enhancer chamber accommodating a first ignition device and an enhancer agent and a space accommodating a gas generating agent, the peripheral surface of the enhancer chamber cup member having a fragile section, the peripheral surface being cleaved at the fragile section by activation of the first ignition device, thereby releasing a combustion product into the space where the gas generating agent is accommodated.

Further, the present invention relates to a gas generator for an air bag, comprising, in a housing having a gas discharge port, a first combustion chamber and a second combustion chamber in which a gas generating agent and an ignition device are provided respectively,

the first combustion chamber being separated by an enhancer chamber cup member, which is disposed in the first combustion chamber, into an enhancer chamber accommodating a first ignition device and an enhancer agent and a space accommodating a gas generating agent,

the peripheral surface of the enhancer chamber cup member having a first fragile section, the peripheral surface being cleaved at the fragile section by activation of the first ignition device, thereby releasing a combustion product into the space where the gas generating agent is accommodated,

the second combustion chamber being separated from the first combustion chamber by a combustion chamber cup member disposed within the housing, a second gas generating agent and a second ignition device being disposed within the combustion chamber cup member,

the peripheral surface of the combustion chamber cup member has a second fragile section, and the peripheral surface being cleaved at the second fragile section by activation of the second ignition device, thereby forming a discharge channel for the gas generated in the second combustion chamber.

Further, the present invention relates to a gas generator for an air bag, including, in a housing having a gas discharge port, a combustion chamber having disposed therein a gas generating agent and an ignition device,

the combustion chamber being separated by an enhancer chamber cup member disposed in the combustion chamber into an enhancer chamber accommodating an ignition device and an enhancer agent and a space accommodating a gas generating agent, and

the peripheral surface of the enhancer chamber cup member having a fragile section, and the peripheral surface being cleaved at the fragile section by activation of the ignition device, thereby releasing a combustion product into the space where the gas generating agent is accommodated.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 shows an axial sectional view of a gas generator;

FIG. 2 shows a perspective view illustrating a fragile section in a combustion chamber cup member;

FIG. 3(a) and FIG. 3(b) show a cross-sectional view in the radial direction of FIG. 2;

FIG. 4 shows a perspective view illustrating a fragile section in the combustion chamber cup member of the gas generator of another embodiment;

FIG. 5(a) to FIG. 5(d) are a explanatory drawings of another embodiment of the fragile section of FIG. 4; and

FIG. 6 shows an axial sectional view of the gas generator of yet another embodiment.

### DETAILED DESCRIPTION OF THE INVENTION

The inflators in U.S. Pat. No. 6,543,805 B2 and JP-A No. 2001-199303 have complicated structures, and therefore cannot respond sufficiently to demands for reduced weight inflators. The inflator in U.S. Pat. No. 6,189,927 B1 (JP-A No. 2002-503584) has a simpler structure than the inflators in U.S. Pat. No. 6,543,805 B2 and JP-A No. 2001-199303, but the second combustion chamber is separated from the first combustion chamber by a fixed member and an insulating member. In the emergency gas generator in JP-A No. H5-168905, because the fractured bottom plate 3 directly and immediately releases gas therefrom, the amount of discharged gas cannot be controlled and the gas generator cannot be employed for dual-type air bags having two ignition devices and combustion chambers.

The present invention provides a gas generator for an air bag in which an overall reduction in weight can be achieved through structural simplification, while maintaining favorable and fine performance and quality levels, and in which the manufacturing process can also be simplified.

The opening of the combustion chamber cup member is in contact with the housing bottom surface, but the ceiling surface of the combustion chamber cup member may or may not be in contact with the housing ceiling surface. It is, however, preferred that the ceiling surface of the combustion chamber cup member and the housing ceiling surface be in contact, because the combustion chamber cup member can be more easily fixed. Furthermore, the combustion chamber cup member of a cylindrical shape, rather than the cup-like shape, may be used, provided that it can separate the interior of the combustion chamber.

The fragile section is provided in the peripheral surface of the combustion chamber cup member and has a strength lower than that of other portions (peripheral surface outside the fragile section). The fragile section acts to cleave (i.e., split open or tear open) the peripheral surface by the pressure applied from the inside. The fragile section can be formed by reducing the thickness of the cup member with respect to that of other portions, forming a linear notch, or providing a groove.

A single or multiple fragile sections can be provided in the peripheral surface of the combustion chamber cup member. The discharge speed of the gas flow released from the second combustion chamber can be controlled by adjusting the formation position, size, and number of fragile sections.

Because the combustion chamber cup member separates the first combustion chamber and second combustion chamber, the combustion chamber cup member has a function of preventing the second gas generating agent provided inside the second combustion chamber from being ignited and combusted by gas generated by combustion of the gas generating agent (first gas generating agent) provided inside the first combustion chamber.

In order to demonstrate such prevention function, the fragile section provided in the peripheral surface of the combustion chamber cup member acts to cause cleaving of the combustion chamber cup member by the pressure applied from the inside, that is, the gas generated by combustion of the second gas generating agent provided inside the second combustion chamber, and the combustion chamber cup member is not cleaved by the pressure applied from the outside, that is, by the pressure of the gas generated by combustion of the first gas generating agent provided inside the first combustion chamber. Cleaving as referred to herein is the process in which the combustion chamber cup member is split open or torn open by fracturing the fragile section, thereby forming a gap sufficient for discharging gas.

Because the combustion chamber cup member is cleaved at the fragile section to form a gas discharge path by the gas generated by the combustion of the second gas generating agent provided inside the second combustion chamber, it is not necessary to form a special gas discharge path (for example, a through hole closed by a sealing unit).

The opening of the enhancer chamber cup member is in contact with the housing bottom surface, but the ceiling surface of the enhancer chamber cup member may or may not be in contact with the housing ceiling surface. It is, however, preferred that the ceiling surface of the enhancer chamber cup member and the housing ceiling surface be in contact, because fixing of the enhancer chamber cup member is facilitated. Furthermore, the enhancer chamber cup member of a cylindrical shape, rather than the cup-like shape, may be used, provided that it can separate the interior of the combustion chamber.

The enhancer chamber cup member separates the enhancer chamber from the charging space of the first gas generating agent, receives the pressure of the combustion product (ignition energy) generated by the combustion of the enhancer agent due to activation of the first ignition device, is cleaved at the fragile section, releases the ignition energy therefrom, and causes ignition and combustion of the first gas generating agent. Ignition and combustion ability of the first gas generating agent can be controlled by adjusting the formation position, size, and number of fragile sections.

Because the enhancer chamber cup member is cleaved at the fragile section to form a discharge path for the combustion product by the combustion product generated by the combustion of the enhancer agent inside the enhancer chamber, it is not necessary to form a special gas discharge path (for example, a through hole closed by a sealing unit).

In the gas generator for an air bag in accordance with the present invention, the fragile sections can be provided both in the peripheral section of the combustion chamber cup member and in the peripheral surface of the enhancer chamber cup member.

The gas generator has a single ignition device and a single combustion chamber, in which a fragile section is provided, in the peripheral surface of the enhancer chamber cup member in the same manner as in the above-described inventions. The enhancer chamber cup member of a cylindrical shape, rather than the cup-like shape, may be used, provided that it can separate the interior of the combustion chamber.

The present invention further relates to the gas generator for an air bag, wherein the fragile section provided in the peripheral surface of the combustion chamber cup member or enhancer chamber cup member is in the form of a groove and is provided continuously or intermittently in the height direction of the peripheral surface.

The groove-shaped fragile section in accordance with the present invention means a fine long section in the form of a line, a curve, or combination thereof. By providing such groove-shaped fragile section in the height direction, the combustion chamber cup member or enhancer chamber cup member is cleaved in a slit-like fashion in the axial direction (a slit passing through the peripheral surface is formed) by activation of the first ignition device or second ignition device, and a gas discharge path or ignition energy release opening is formed.

The present invention further relates to the gas generator for an air bag, wherein the fragile section provided in the peripheral surface of the combustion chamber cup member or enhancer chamber cup member is in the form of a groove and is provided continuously or intermittently in the circumferential direction of the peripheral surface.

The groove-shaped fragile section in accordance with the present invention means a fine long section in the form of a line, a curve, or combination thereof. By providing such groove-shaped fragile section in the circumferential direction, the combustion chamber cup member or enhancer chamber cup member is cleaved in a slit-like fashion (a slit passing through the peripheral surface is formed) by activation of the first ignition device or second ignition device, and a gas discharge path or ignition energy release opening is formed.

In the case where a groove-shaped fragile section is formed continuously or intermittently (for example, in the form of a dot line) along the entire circumference, when the combustion chamber cup member or enhancer chamber cup member receives pressure, the cup member is separated in two along the fragile section. As a result, when the ceiling section of the combustion chamber cup member or enhancer chamber cup member is not in contact with the ceiling surface of the housing, the separated upper portion is propelled toward the ceiling surface of the housing. When the ceiling section of the combustion chamber cup member or enhancer chamber cup member is in contact with the ceiling surface of the housing, a slit is just formed in the circumferential direction.

The present invention further relates to the gas generator for an air bag, wherein the fragile section provided in the peripheral surface of the combustion chamber cup member or the enhancer chamber cup member is in the form of a groove, and the groove-shaped fragile section has a recess in at least one end section thereof.

The groove-shaped fragile section in accordance with the present invention means a fine long section in the form of a line, a curve, or combination thereof. The “recess” provided in at least one end section of the groove is a concave section of a round shape or a shape similar thereto, or a short groove perpendicular or oblique (crosses obliquely) to the lengthwise direction of the groove.

For example, in the case where the fragile section in the form of a linear groove (a length of 50 mm close to the central section in the height direction) is provided in the height direction in the peripheral surface (height is taken as 100 mm) of the combustion chamber cup member, when the groove is cleaved due to activation of the second ignition device, the length of the cleavage will not stop at 50 mm and cleavage will further extend from the groove end and will apparently finally extend from the peripheral edge of the opening to the bottom (in other words, the length will be 100 mm or more). When the cleavage thus occurs in excess of the initial length of the fragile section, the interior of the combustion chamber cup member will not be able to maintain the predetermined pressure and the designed combustion of gas generating agent will not be conducted.

However, when a recess is provided in the groove end section, even when the groove is cleaved and reaches the end section, further extension of the cleavage is blocked by the recess. When the fragile section is a linear groove with a length of 10 mm, the recess can be a round concave section with a diameter of about 2 to 5 mm or a linear groove with a length of about 2 to 8 mm.

The present invention further relates to the gas generator for an air bag, wherein the fragile section provided in the peripheral surface of the combustion chamber cup member or the enhancer chamber cup member is in the form of a groove, and the groove has a V-like shape in the widthwise direction.

The V-like shape as referred to herein includes both the V-like shape oriented from inside outward and from outside inward of the combustion chamber cup member or enhancer chamber cup member in the widthwise sectional view of the groove-shaped fragile section. Incidentally, the shape of the groove in the widthwise direction may be a U-like shape or a shape similar thereto, or a cup-like shape or a shape similar thereto other than the V-like shape.

The gas generator for an air bag of the present invention has a simplified structure, and therefore the manufacturing process can also be simplified and a reduction in the overall weight thereof can be achieved.

### EMBODIMENTS OF THE INVENTION

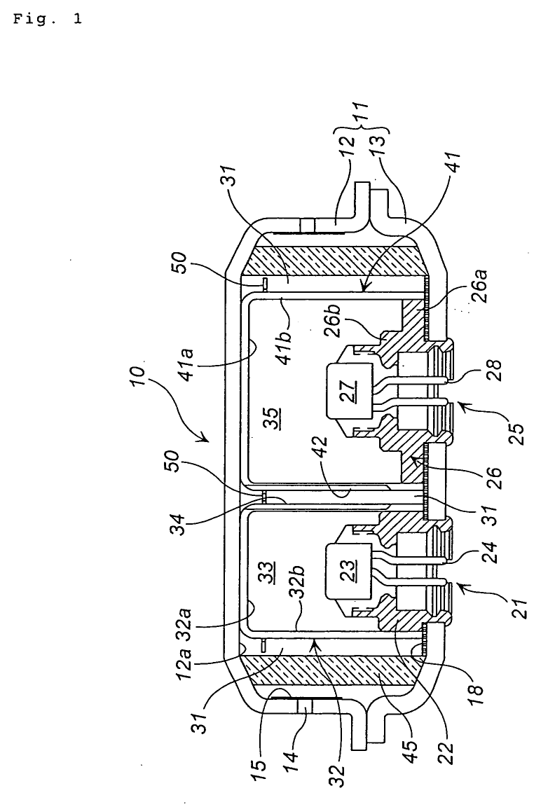

(1) Gas Generator for an Air Bag Shown in FIGS. 1 to 3.

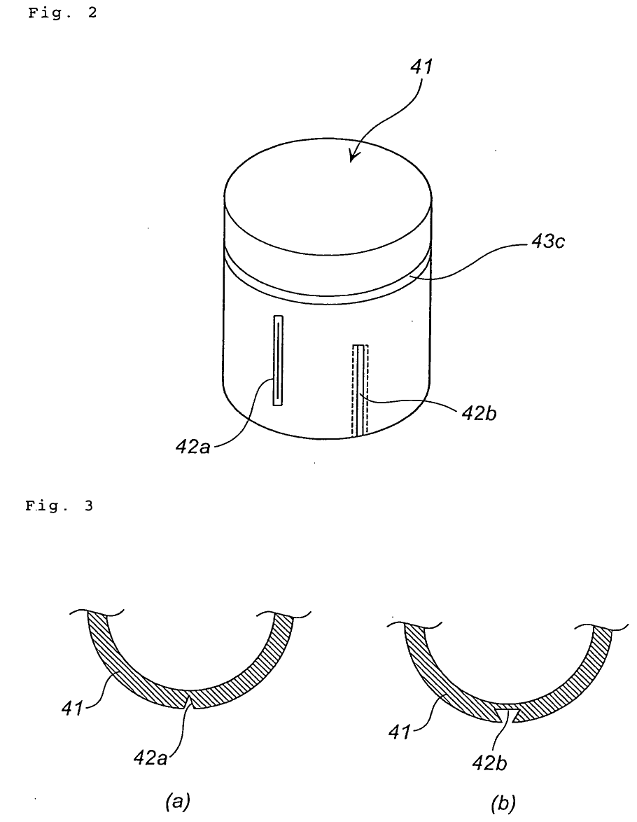

An embodiment of the present invention will now be described with reference to FIGS. 1 to 3. FIG. 1 shows an axial sectional view of a gas generator for an air bag. FIG. 2 shows a perspective view illustrating a plurality of modes of forming a fragile section in a combustion chamber cup member or an enhancer chamber cup member shown in FIG. 1. FIGS. 3(a), (b) show cross-sectional views in the radial direction of FIG. 2.

An outer shell of a gas generator 10 for an air bag is formed from a housing 11 in which a diffuser shell 12 and a closure shell 13 are joined integrally. The diffuser shell 12 and closure shell 13 are welded at a joint portion where flanges of the diffuser and closure shells meet.

A plurality of gas discharge ports 14 are provided in the peripheral wall of the diffuser shell 12, and the gas discharge ports 14 are sealed from the inside by a sealing tape 15 made of aluminum or stainless steel.

Two holes are provided in the bottom surface of the closure shell 13, and a first ignition device 21 and a second ignition device 25 are fitted into respective holes such that moisture from the outside atmosphere can be prevented from entering.

The first ignition device 21 has a first igniter 23 fixed to a first igniter collar 22. A connector (not shown) having a lead wire is fitted onto two conductive pins 24 extending from the first igniter 23, and a battery power is selectively applied to the pins 24 through the wire.

The second ignition device 25 has a second igniter 27 fixed to a second igniter collar 26. A connector (not shown) having a lead wire is fitted onto two conductive pins 28 extending from the second igniter 27, and a battery power is selectively applied to the pins 28 through the wire. The second igniter collar 26 has a larger diameter portion 26a and a smaller diameter portion 26b.

A first combustion chamber 31 and a second combustion chamber 35 are provided in the housing 11, and the second combustion chamber 35 is separated from the first combustion chamber 31 by a combustion chamber cup member 41. In FIG. 1, the second combustion chamber 35 is housed within the first combustion chamber 31, but the first combustion chamber 31 and the second combustion chamber 35 may be disposed adjacent to each other. A first gas generating agent (not shown in the drawing) is charged into first combustion chamber 31, and a second gas generating agent (not shown in the drawing) is charged into the second combustion chamber 35.

An enhancer chamber cup member 32 is disposed inside the first combustion chamber 31, and the interior of the enhancer chamber cup member 32 serves as an enhancer chamber 33 and accommodates an enhancer agent (not shown in the drawing) and the second ignition device 21.

The opening of the enhancer chamber cup member 32 is fitted around the first igniter collar 22, the peripheral edge of the opening of the enhancer chamber cup member abuts against a gasket 18 disposed on the bottom surface of the housing 11, and a bottom 32a of the enhancer chamber cup member 32 abuts against a ceiling surface 12a of the housing 11. As a result, the enhancer chamber cup member 32 is positioned by the first igniter collar 22 and fixed so as to be pushed from above and below by the ceiling surface 12a and gasket 18 respectively.

The combustion chamber cup member 41 forming the second combustion chamber 35 is press-fitted onto the larger diameter portion 26a of the second igniter collar 26, the outer diameter of which is greater than the inner diameter of the combustion chamber cup member 41. By press-fitting the combustion chamber cup member 41 around the larger diameter portion 26a in this manner, the combustion chamber cup member 41 is positioned and prevented from moving in axial and radial directions.

The peripheral edge of the opening of the combustion chamber cup member 41 abuts against the gasket 18 disposed on the bottom surface of the housing 11, and a bottom 41a abuts against the ceiling surface 12a of the housing 11. As a result, the combustion chamber cup member 41 is pushed from above and below and fixed by the ceiling surface 12a and gasket 18. The use of the gasket 18 is optional.

A disk-shaped retainer 50, for adjusting the volume of the first combustion chamber 31 in accordance with the charged amount of the first gas generating agent, is fitted into the first combustion chamber 31. The retainer 50 has two holes, and those two holes are fitted onto the combustion chamber cup member 41 and the enhancer chamber cup member 32.

A cylindrical coolant/filter 45, which has finctions of filtering and cooling combustion gas, is disposed on the outside of the first combustion chamber 31, and a gap is provided between the outer peripheral surface of the coolant/filter 45 and the gas discharge ports 14 and sealing tape 15.

A groove-like (linear groove) fragile section 42 is provided in the height direction (axial direction of the housing 11) in a peripheral surface 41b of the combustion chamber cup member 41. On the other hand, a groove-like (linear groove) fragile section 34 is provided in the height direction (axial direction of the housing 11) in a peripheral surface 32b of the enhancer chamber cup member 32.

The groove-like fragile section 42 shown in FIG. 1 is provided within the range from about ⅓ of the height from the opening of the combustion chamber cup member 41 to the bottom 41a, but it may be also provided close to the central portion of the peripheral surface, as a fragile section 42a shown in FIG. 2, or it may be provided within the range of about half the height from the opening, as the fragile section 42b in FIG. 2.

As shown in FIG. 3(a), the fragile section 42a is a V-shaped groove that is oriented outwardly from the inside the combustion chamber cup member 41 in the radial sectional view, and as shown in FIG. 3(b), the fragile section 42b is a V-shaped groove that is oriented inwardly from the outside of the combustion chamber cup member 41 (the inverted V shape with respect to that shown in FIG. 3(a)). With the V-like and inverted V-like shape, such as shown in FIGS. 3(a), 3(b), when a pressure is received from the outside, the circumference of the open portion of the V-shaped groove is pushed, causing the deformation that closes the open portion. Therefore, the fragile sections 42a, 42b are prevented from being cleaved (split open or torn open) by the external pressure (a pressure created by the gas generated by the activation of the first ignition device).

As shown in FIG. 2, the fragile section also can be made as a fragile section 43c in the form of continuous (or intermittent) circumferential groove. The fragile section 43c may be in the form of a groove similar to any of the cross-sectional shapes shown in FIGS. 3(a), 3(b).

The fragile section 34 of the enhancer chamber cup member 32 can be formed in the same manner as the fragile section 42 of the combustion chamber cup member 41.

The operation of the gas generator for an air bag shown in FIG. 1 when applied to an air bag system of an automobile will be described below. Depending on the extent of an impact received by the automobile during a collision, the first igniter 23 and the second igniter 27 may be activated in any of the following three patterns: only the first igniter 23 is activated; the first igniter 23 is activated first and the second igniter 27 is activated with a delay; or the first igniter 23 and the second igniter 27 are activated simultaneously. The case where the first igniter 23 is activated first and the second igniter 27 is activated with a delay will be described below.

When an automobile receives an impact upon a collision, an activation signal is received from a control unit (not shown), whereby the first igniter 23 is activated and ignited, causing ignition and combustion of the enhancer agent. The pressure rises inside the enhancer chamber 33, whereby the fragile section 34 is cleaved, a slit is formed, and the combustion product (ignition energy) is discharged therefrom into the first combustion chamber 31.

The discharge of the combustion product causes ignition and combustion of the first gas generating agent and high-temperature combustion gas is generated. The combustion gas is filtered and cooled as it passes through the coolant/filter 45, whereupon the combustion gas ruptures the sealing tape 15 and is discharged through the gas discharge ports 14 to inflate the air bag. At this time, the second combustion chamber 35 is surrounded by the cup member 41 and the fragile section 42 is not cleaved by the external pressure. Therefore, the combustion gas generated in the first combustion chamber 31 does not flow into the second combustion chamber 35.

Then, the second igniter 27 is activated and ignited with a slight delay, whereby the second gas generating agent is ignited and combusted and high-temperature combustion gas is generated. The fragile section 42 of the combustion chamber cup member 41 forming the second combustion chamber 35 is cleaved by the pressure from the high-temperature combustion gas and a slit is formed. The combustion gas then flows out from the slit and is filtered and cooled as it passes through the coolant/filter 45, whereupon the combustion gas is discharged through the gas discharge ports 14 and further inflates the air bag.

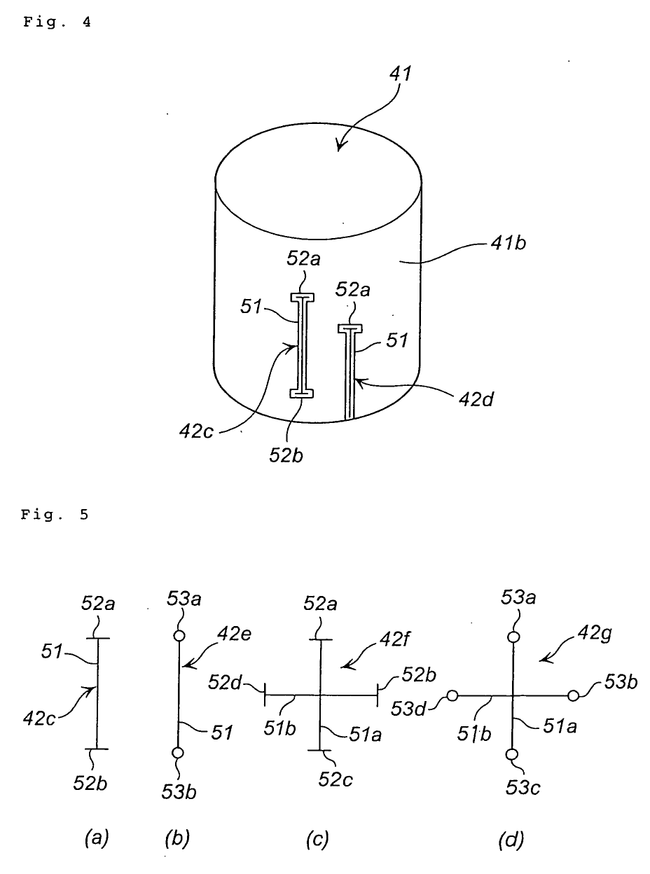

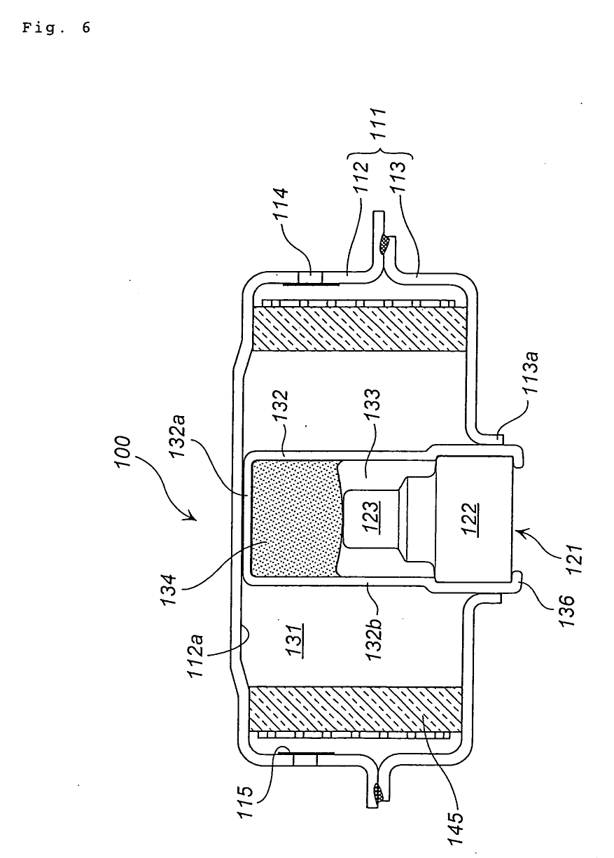

(2) Gas Generator for an Air Bag Shown in FIG. 4 and FIG. 5

FIG. 4 is a perspective view illustrating a plurality of modes of forming a fragile section in the combustion chamber cup member or enhancer chamber cup member in the gas generator for an air bag of an aspect different from that shown in FIG. 1. FIG. 5(a) to FIG. 5(d) are schematic plan views of the fragile section shown in FIG. 4 as well as other forms of fragile sections. The case where a fragile section was provided in the combustion chamber cup member will be explained below, but a similar fragile section can be also provided in the enhancer chamber cup member.

A groove-shaped fragile section 42c or 42d can be provided in the height direction (axial direction of the housing 11) in the peripheral surface 41b of the combustion chamber cup member 41.

The fragile section 42c shown in FIG. 4 is formed close to the central portion of the peripheral surface 41b and has a splittable section 51 composed of a linear groove and recesses 52a, 52b formed at both ends of the splittable section 51. The recesses 52a, 52b are short grooves of the same width as the splittable section 51 and are formed so as to be perpendicular to the lengthwise direction of the splittable section 51. The cross-sectional shape in the widthwise direction of the recesses 52a, 52b can be formed as shown in FIG. 3(a) or FIG. 3(b).

The fragile section 42d shown in FIG. 4 is formed in the range of the height portion that is about a half way from the opening and has a splittable section 51 composed of a linear groove and a recess 52a formed at one end of the splittable section 51. The recess 52a is a short groove of the same width as the splittable section 51 and is formed so as to be perpendicular to the lengthwise direction of the splittable section 51. The cross-sectional shape in the widthwise direction of the recess 52a can be formed as shown in FIG. 3(a) or FIG. 3(b).

The fragile section 42c shown in FIG. 4 corresponds to that shown in FIG. 5(a), but can be also formed as shown in FIGS. 5(b) to 5(d).

A fragile section 42e shown in FIG. 5(b) has a splittable section 51 composed of a linear groove and concave sections 53a, 53b formed at both ends of the splittable section 51. The concave sections 53a, 53b are shallow recesses of a round planar shape or a shape similar thereto.

A fragile section 42f shown in FIG. 5(c) includes a first splittable section 51a composed of a linear groove extending in the vertical direction and a second splittable section 51b composed of a linear groove extending in the direction perpendicular to the first splittable section 51a. Here, recesses 52a, 52c (short grooves of the same width as the first splittable section 51a) are formed at both ends of the first splittable section 51a, and recesses 52b, 52d (short grooves of the same width as the second splittable section 51b) are formed at both ends of the second splittable section 51b.

A fragile section 42g shown in FIG. 5(d) includes a first splittable section 51a composed of a linear groove extending in the vertical direction and a second splittable section 51b composed of a linear groove extending in the direction perpendicular to the first splittable section 51a.

Here, concave sections 53a, 53c (shallow recesses of a round planar shape or a shape similar thereto) are formed at both ends of the first splittable section 51a, and concave sections 53b, 53d (shallow recesses of a round planar shape or a shape similar thereto) are formed at both ends of the second splittable section 51b.

The operation of the gas generator for an air bag shown in FIG. 1 (the gas generator using the enhancer chamber cup member 32 having the fragile section 34 identical to the fragile section 42c shown in FIG. 4 and FIG. 5(a) and the combustion chamber cup member 41 having the fragile section 42c shown in FIG. 4 and FIG. 5(a)) when applied to an air bag system of an automobile will be described below. The case where the first igniter 23 is activated first and the second igniter 27 is activated with a delay will be described below.

When an automobile receives an impact upon a collision, an activation signal is received from a control unit (not shown), whereby the first igniter 23 is activated and ignited, causing ignition and combustion of the enhancer agent. The pressure rises thereafter inside the enhancer chamber 33, whereby the fragile section 34 is cleaved, a slit is formed, and the combustion product (ignition energy) is discharged therefrom into the first combustion chamber 31.

At this time, because the fragile section 34 is formed identical to the fragile section 42c shown in FIG. 4, even if the entire splittable section 51 was cleaved in the lengthwise direction, further cleaving in the lengthwise direction will be blocked at the recesses 52a, 52b in both end sections. As a result, because cleaving in excess of the length of the splittable section 51 is prevented, the interior of the enhancer chamber cup member 32 can maintain the combustion state as designed.

The discharge of the combustion product causes ignition and combustion of the first gas generating agent and high-temperature combustion gas is generated. The combustion gas is filtered and cooled as it passes through the coolant/filter 45, whereupon the combustion gas ruptures the sealing tape 15 and is discharged through the gas discharge ports 14 to inflate the air bag. At this time, the second combustion chamber 35 is surrounded by the cup member 41 and the fragile section 42 is not cleaved by the external pressure. Therefore, the combustion gas generated in the first combustion chamber 31 does not flow into the second combustion chamber 35.

The second igniter 27 is activated and ignited with a slight delay, whereby the second gas generating agent is ignited and combusted and high-temperature combustion gas is generated. The fragile section 42 of the combustion chamber cup member 41 forming the second combustion chamber 35 is cleaved by the pressure from the high-temperature combustion gas and a slit is formed. The combustion gas then flows out from the slit and is filtered and cooled as it passes through the coolant/filter 45, whereupon the combustion gas is discharged through the gas discharge ports 14 and further inflates the air bag.

At this time, even if the entire splittable section 51 is cleaved in the lengthwise direction in the fragile section 42c, further cleaving in the lengthwise direction is blocked at the recesses 52a, 52b in both end sections. As a result, because cleaving in excess of the length of the splittable section 51 is prevented, the interior of the combustion chamber cup member 41 can maintain the combustion state as designed.

(3) Gas Generator for an Air Bag Shown in FIG. 6

FIG. 6 is a longitudinal sectional view of a gas generator for an air bag which is provided with one combustion chamber.

An outer shell of the gas generator 100 is formed of a housing 111 in which a diffuser shell 112 and a closure shell 113 are joined integrally. The diffuser shell 112 and closure shell 113 are welded at a joint portion where flanges of the diffuser and closure shells meet.

A plurality of gas discharge ports 114 are provided in the peripheral wall of the diffuser shell 112, and the gas discharge ports 114 are sealed from the inside by a sealing tape 115 made of aluminum or stainless steel.

A single hole is provided in the bottom surface of the closure shell 113, and an ignition device 121 is fitted therein such that moisture from the outside atmosphere can be prevented from entering.

The ignition device 121 has an igniter 123 fixed to an igniter collar 122. A connector having a lead wire (not shown) is fitted onto two conductive pins (not shown) extending from the igniter 123, and the connector is connected to a battery through the lead wire.

A combustion chamber 131 is provided inside the housing 111, and a first gas generating agent (not shown) is charged into the interior of the combustion chamber 131.

An enhancer chamber cup member 132 is disposed inside the combustion chamber 131, and the interior of the enhancer chamber cup member 132 serves as an enhancer chamber 133 and accommodates an enhancer agent 134 loaded into an aluminum container.

The opening of the enhancer chamber cup member 132 is fitted around the igniter collar 122, the peripheral edge 136 of the opening of the enhancer chamber cup member protrudes outwardly from the hole provided in the bottom surface of the closure shell 113, and the igniter collar 122 is fixed by caulking the peripheral edge 136 of the opening. Furthermore, the peripheral edge 136 of the opening is sandwiched and fixed by the flange section 113a defining the hole of the closure shell 113. A bottom 132a of the enhancer chamber cup member 132 abuts against a ceiling surface 112a of the housing 111.

An annular retainer (not shown), for adjusting the volume of the combustion chamber 131 in accordance with the charged amount of the gas generating agent, can be disposed in the combustion chamber 131. The retainer can be fitted and mounted on the enhancer chamber cup member 132.

A cylindrical coolant/filter 145, which has functions of filtering and cooling combustion gas, is disposed on the outside of the combustion chamber 131, and a gap is provided between the outer peripheral surface of the coolant/filter 145, and the gas discharge ports 114 and sealing tape 115.

A groove-like (linear groove) fragile section 42c such as that shown in FIG. 4 is provided in the height direction (axial direction of the housing 111) in the peripheral surface 132b of the enhancer chamber cup member 132. The fragile section 42c can have a shape such as those shown in FIGS. 5(b) to 5(d).

The operation of the gas generator shown in FIG. 6 (the gas generator using the enhancer chamber cup member 132 having the fragile section identical to the fragile section 42c shown in FIG. 4 and FIG. 5(a)) when applied to an air bag system of an automobile will be described below.

When an automobile receives an impact upon a collision, an activation signal is received from a control unit (not shown), whereby the igniter 123 is activated and ignited, causing ignition and combustion of the enhancer agent 134. The pressure rises thereafter inside the enhancer chamber 133, whereby the fragile section 42c is cleaved, a slit is formed, and the combustion product (ignition energy) is discharged therefrom into the combustion chamber 131.

At this time, even if the entire splittable section 51 was cleaved in the lengthwise direction, further cleaving in the lengthwise direction is blocked at the portions of the recesses 52a, 52b in both end sections. As a result, because cleaving in excess of the length of the splittable section 51 is prevented, the interior of the enhancer chamber cup member 132 can maintain the combustion state as designed.

The discharge of the combustion product causes ignition and combustion of the gas generating agent and high-temperature combustion gas is generated. The combustion gas is filtered and cooled as it passes through the coolant/filter 145, whereupon the combustion gas ruptures the sealing tape 115 and is discharged through the gas discharge ports 114 to inflate the air bag.

The invention thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A gas generator for an air bag, comprising:
a housing having a gas discharge port;
a first combustion chamber and a second combustion chamber, included in the housing;
a gas generating agent and an ignition device provided in each of the first combustion chamber and the second combustion chamber;
a combustion chamber cup member provided in the housing for separating the second combustion chamber from the first combustion chamber; and
a gas generating agent and an ignition device disposed within the combustion chamber cup member,
wherein, a peripheral surface of the combustion chamber cup member has a fragile section, and
the peripheral surface is adapted to be cleaved at the fragile section by an activation of the ignition device, thereby forming a discharge channel for the gas generated in the second combustion chamber.

2. A gas generator for an air bag, comprising:
a housing having a gas discharge port;
a first combustion chamber and a second combustion chamber, included in the housing;
a gas generating agent and an ignition device, provided in each of the first combustion chamber and the second combustion chamber; and,
an enhancer chamber cup member provided in the housing for separating, from the first combustion chamber, an enhancer chamber accommodating a first ignition device, an enhancer agent, and a space accommodating a gas generating agent,
wherein, a peripheral surface of the enhancer chamber cup member has a fragile section, the peripheral surface is adapted to be cleaved at the fragile section by an activation of the first ignition device, thereby releasing a combustion product into the first combustion chamber.

3. A gas generator for an air bag, comprising:
a housing having a gas discharge port;
a first combustion chamber and a second combustion chamber, included in the housing;
a gas generating agent and an ignition device, provided in each of the first combustion chamber and the second combustion chamber;
an enhancer chamber cup member provided in the housing for separating, form the first combustion chamber,
an enhancer chamber accommodating a first ignition device, an enhancer agent, and a space accommodating a gas generating agent, a peripheral surface of the enhancer chamber cup member having a fragile section, the peripheral surface being adapted to be cleaved at the fragile section by an activation of the first ignition device, thereby releasing a combustion product into the first combustion chamber; and
a combustion chamber cup member provided in the housing for separating, the second combustion chamber from the first combustion chamber, the second combustion chamber, the combustion cup member accommodating a second gas generating agent and a second ignition device, a peripheral surface of the combustion chamber cup member having a fragile section, and the peripheral surface being adapted to be cleaved at the fragile section by an activation of the second ignition device, thereby forming a discharge channel for the gas generated in the second combustion chamber.

4. A gas generator for an air bag, comprising:
a housing having a gas discharge port;
a combustion chamber provided in the housing;
a gas generating agent and an ignition device, provided in the combustion chamber;
an enhancer chamber cup member provided in the combustion chamber for separating, from the combustion chamber, an enhancer chamber accommodating an ignition device, an enhancer agent, a peripheral surface of the enhancer chamber cup member having a fragile section, the peripheral surface being adapted to be cleaved at the fragile section by an activation of the ignition device, thereby releasing a combustion product into the combustion chamber.

5. The gas generator for an air bag according to any one of claims 1 to 4, wherein the fragile section provided on the peripheral surface of the combustion chamber cup member or enhancer chamber cup member is in the form of a groove and the fragile section is provided continuously or intermittently in the height direction of the peripheral surface.

6. The gas generator for an air bag according to any one of claims 1 to 4, wherein the fragile section provided in the peripheral surface of the combustion chamber cup member or enhancer chamber cup member is in the form of a groove and the fragile section is provided continuously or intermittently in the circumferential direction of the peripheral surface.

7. The gas generator for an air bag according to any one of claims 1 to 4, wherein the fragile section provided in the peripheral surface of the combustion chamber cup member or the enhancer chamber cup member is in the form of a groove, and the groove-shaped fragile section has a recess in at least one end section thereof.

8. The gas generator for an air bag according to any one of claims 1 to 4, wherein the fragile section provided in the peripheral surface of the combustion chamber cup member or the enhancer chamber cup member is in the form of a groove, and the groove has a V-like shape formed in a radial direction.
